(19) United States
(12) Patent Application Publication
(10) Pub. No.: US 2007/0239726 A1
(43) Pub. Date: Oct. 11, 2007

(54) Systems and methods of transforming data for web communities and web applications

(76) Inventors: Mathew Girard Weiss, Orlando, FL (US); Michael R. Thacker, Orlando, FL (US); Andress Solymonsi, (US)

Correspondence Address: SUTHERLAND ASBILL & BRENNAN LLP, 999 PEACHTREE STREET, N.E., ATLANTA, GA, 30309, US

(21) Appl. No.: 11/391,998

(22) Filed: Mar. 29, 2006

(51) Int. Cl. G06F 17/30

(52) U.S. Cl. 707/10

(57) ABSTRACT

Systems and methods for modifying the content of portal screens associated with a web community that include one or more web communities accessible by at least one server through a network, where each web community is associated with one or more portal screens and each portal screen is associated with particular report data. Moreover, a user computer device, capable of accessing and rendering one or more portal screens, is connected to the server(s) through the network, where the server(s) may access report data. The user computer device provides access to a user interface associated with the portal screens that may provide access to a file browser for querying a remote data source through the network to locate and retrieve the report data to be associated with one or more portal screens. Additionally, several tools for altering the retrieved report data may be accessible through the user interface.

### FIELD OF THE INVENTION

The invention relates to internet applications. More specifically, the invention relates to portal functionality and tools for retrieving, manipulating and transforming content from various internet resources and web communities.

### BACKGROUND OF THE INVENTION

Many organizations utilize web technologies to conduct business transactions, advertise to the public, disseminate information to members, patrons, etc. Such uses are often achieved through the use of organizational web sites, extranets, intranets, blogs, message boards, web communities, etc. Many of these organizations utilizing such technologies have a designated group of people who create and maintain their web sites at a centralized location utilizing off the shelf web page creation software, browser based web site creation software, or a combination of the two. Currently, there are a number of web page content creating software programs that are browser-based. Such programs are written in Javascript or Flash and may require Active X controls that allow a user to build web pages through a web browser. These web authoring tools work with pure HTML tags when a user is editing or creating a web page.

However, many of these organizations are geographically dispersed across the world as loosely coupled autonomous satellite locations (i.e., each satellite location maintains, for example, some financial independence and make many self-governing decisions, but share, for example, common goals, practices, and information with other locations). For example, an organization can have a headquarters location where a CEO, Board of Directors or various other leaders set broad goals and policies for the entire organization including its satellite locations. These policies must be implemented at all locations associated with the organization. The remote locations associated with the organization must implement those policies, as well as communicate with its local members, community, customers, patrons, etc.

With just a few broad goals connecting the satellite locations, sharing information and communications between satellite locations may be rare or cumbersome. Such autonomous satellite locations may create many redundancies in the creation of web content associated with the organization. Additionally, creating and maintaining an organization's web content and applications utilizing centralized administration with conventional off-the-shelf web page creation software, browser based web site creation software, or a combination of the two is often difficult and costly. Moreover, administering the web content and applications of a plurality of satellite locations utilizing centralized web administration can be cumbersome for reasons including not every location being equal in size, not every location having the financial ability to utilize the latest in communication technology, language barriers, etc. As an additional obstacle to decentralizing web application administration, not every location may be able to afford to have a person creating and maintaining their local web applications.

These above stated problems and limitations are not easily handled by current uses of extranets, intranets company web sites, and blogs, nor are they alleviated or solved by utilizing conventional off the shelf web page creation software, browser based web site creation software, or a combination of the two. Thus, the use of such web technologies for such widespread organizations may be riddled with inefficiencies, ineffectiveness, and added expense. What is need is a way of customizing web applications and content associated with various interconnected web communities in a user-friendly way that address the issues discussed above.

### SUMMARY OF THE INVENTION

According to an embodiment of the invention, there is disclosed a system for modifying the content of portal screens associated with a web community that include one or more web communities accessible through a network, where each web community is associated with one or more portal screens and each portal screen is associated with particular report data. A user computer device, capable of accessing and rendering one or more portal screens, provides access to a user interface associated with the portal screens that may provide access to a file browser for querying a remote data source through the network to locate and retrieve the report data to be associated with one or more portal screens. Moreover, a user computer device, , is connected to the server(s) through the network, where the server(s) is operable to retrieve at least some of the report data, identify an abstract data type associated with the report data; transform the retrieved report data into an abstract data type; execute one or more structure transformations on the abstract data type to achieve a desired data structure; and transmit the desired data structure through the network to the user computer device.

According to one aspect of the invention, several tools for altering the retrieved report data interface to be displayed on a user computer device may be accessible through the user. In accordance with another aspect of the invention, one or more tools are included in the user interface such as a box tool, report tool, form tool, translate tool, community tool, style tool or a module tool. According to yet another aspect of the invention, the portal screens are web pages. In accordance with yet another aspect of the invention, the remote database may be a resource center, local database, or an external data source.

According to another embodiment of the invention, there is disclosed a method of modifying the content on a portal screen using a tool box interface. The method includes creating a box on the portal screen through the tool box interface; associating at least one report with the box, where the report is, in turn, associated with portal screen content; modifying the portal screen content associated with the report according to selections entered through the tool box interface; and rendering the portal screen content associated with the report on the portal screen.

According to one aspect of the invention, the method further includes querying either a resource center, local database, or external data source through a file browser associated with the tool box interface to retrieve the report to be associated with the box. In accordance with another aspect of the invention the step of modifying the portal screen content associated with the report according to selections entered through the tool box interface includes entering the selections through a structure tool interface and a style tool interface, where a data structure to be associated with the portal screen content is selected through the structure tool interface and a plurality of style attributes to be associated with the portal screen content is selected through the style tool interface. According to yet another aspect of the invention the step of modifying the portal screen content associated with the report according to selections entered through the tool box interface includes entering the selections through one or more (what you see is what you get) WYSIWYG editors accessible through the tool box interface. In accordance with yet another aspect of the invention the step of rendering the portal screen content associated with the report on the portal screen includes displaying the portal screen content associated with report inside the box associated with the report.

According to yet another embodiment of the invention, there is disclosed a method of data transformation. The method includes extracting a report name from a report definition; retrieving report data corresponding to the extracted report name; identifying an abstract data type associated with the report data; transforming the retrieved report data into an abstract data type; and executing one or more structure transformations on the abstract data type to achieve a desired data structure.

According to one aspect of the invention, the method further includes determining one or more desired style attributes to be associated with the desired data structure; associating the desired style attributes with the desired data structure; formatting the data to be rendered on a particular output device; and rendering the desired data structure on an output device. In accordance with another aspect of the invention, the step of retrieving report data corresponding to the extracted report name includes accessing a database where the report data is located. According to yet another aspect of the invention, the step of retrieving report data corresponding to the extracted report name includes utilizing Simple Object Access Protocol (SOAP) calls to retrieve the report data. In accordance with yet another aspect of the invention the step of retrieving report data corresponding to the extracted report name includes wrapping the column names associated with the report data around the report data as Extensible Markup Language (XML) tags.

According to another aspect of the invention, the step of transforming the retrieved report data into an abstract data type includes changing the XML tags wrapped around the report data based at least in part on the desired data structure. In accordance with another aspect of the invention, the method further includes building cascading style sheets (“CSS”) tags associated with the style attributes of the report data. According to yet another aspect of the invention, the method further includes processing the report data with external application software; and making the processed report data available for download. In accordance with yet another aspect of the invention, the method may also includes building CSS tags associated with the style attributes of the report data; and the step of associating the desired style attributes with the desired data structure may include converting the CSS tags associated with the style attributes of the report data based at least in part on the desired style attributes. According to yet another aspect of the invention, the step of rendering of the desired data structure on an output device may be done by refreshing only a portion of the screen associated with the output device.

### DESCRIPTION OF THE FIGURES

Having thus described the invention in general terms, reference will now be made to the accompanying drawings, which are not necessarily drawn to scale, and wherein:

FIG. 1 shows the communication between communities and various exemplary devices and exemplary types of users in the portal system in accordance with an exemplary embodiment of the invention.

FIG. 2 is a block diagram of the overall portal system in accordance with an exemplary embodiment of the invention.

FIG. 3 is a exemplary layout of a portal screen in accordance with an embodiment of the invention.

FIG. 4 is an illustrative wizard user interface for creating communities in accordance with an exemplary embodiment of the invention.

FIG. 5 is an illustrative user interface of a box tool of the tool box (or tool palette) interface used in accordance with an exemplary embodiment of the invention.

FIG. 6 is an illustrative user interface of the resource center file browser interface of an exemplary embodiment of the invention used searching for desired previously created reports associated with another portal screen in accordance with an exemplary embodiment of the invention.

FIG. 7 show the first phase of the pipeline process in accordance with an exemplary embodiment of the invention.

FIG. 8 show the second phase of the pipeline process in accordance with an exemplary embodiment of the invention.

FIG. 9 show the third phase of the pipeline process in accordance with an exemplary embodiment of the invention.

### DETAILED DESCRIPTION OF THE INVENTION

The invention relates to portal functionality and tools for sharing, manipulating and transforming data retrieved from various web sites, databases and web communities for the purposes of building and maintaining portal screens (e.g., web pages) associated with one or more web communities. For the purposes of the description of the invention, the terms “portal screens” and “pages” are synonymous with terms such as web pages and HTML pages being example of types of portal screens or pages. Content utilized by portal screens may be accessed and retrieved for display on another portal screen or use in another community. Further, the shared data may easily be manipulated by automatically changing the data structure or style attributes (i.e., the “look-and-feel”) of the retrieved content, thereby being presented on another portal screen in a different way. The portal system of the invention allows for the creation of web communities and portal screens associated with those communities and may include an ever growing amount of content accessible by various users of the portal system including members of web communities, community/system administrators, web site or web community visitors and/or other portal system users. In particular, the portal system of the invention provides extensive customization options for web community members and administrators.

The portal functionality of the invention allows for collaboration in web community development by allowing community administrators, portal screen designers/developers and community members to share information including raw data as well their best practices of utilizing that data in a variety of structures, styles, and formats. Web applications may also be built and shared, and web programmers may be active participants in the collaboration of web community development. Such distributed administration of the structure of a web community is advantageous in organizations which are widely dispersed and/or constantly expanding and changing.

With a decentralized administration structure, the portal system of the invention allows for portal customization on two levels. One level of portal customization is directed to a community administrator, where such an administrator can customize the data structures (e.g., a list, table, pull down menu, image etc.) associated with particular content and the style attributes (e.g., colors, font types, font sizes, arrangement, etc.) with which those data structures are presented, also referred to as the “look-and-feel” of a community's content. Additionally, the administrator may inherit content and its associated structure and style attributes from a related web community. For example, changes in the parent community may be reflected in the child community. The community administrator may be in control of, for example, community membership, sub-communities, content, default data structures and style attributes, default arrangements of content on a web page, etc.

On a second customization level a community member may choose a main community and become a member of other communities. A member can change the look-and-feel of the member's own web page(s), rearrange content, delete or add some of the content (if allowed by the community administrator), or utilize content of more than one community (shared content). The invention allows for such customization in the user's browser while “on-line.” In other words, no local copy of the web page, nor other program (HTML editor, etc.) is necessary to create web content.

To allow for the distributed administration of various web communities, the portal system utilizes various well formed data formats using markup languages such as XML (Extensible Markup Language), XHTML (Extensible HyperText Markup Language), XSL (Extensible Style Language), XSP (Extensible Server Pages), XSLT (XSL Transformations), or other similar data formats, to allow data sets to be easily shared between web communities. XML allows designers to create their own customized tags, enabling the definition, transmission, validation, and interpretation of data between applications and between organizations. XML is not a fixed set of elements like HTML, but rather, it is a meta-language, that is, a language for describing the structure of data. XML was designed to describe data, whereas HTML was designed to display data. XML enables authors to define their own “tags” used to manipulate the structure of data providing functionality not available with HTML. XML documents comprise a data set and tags, and the tags imply a tree structure upon the document. If the XML document is properly structured, i.e., the tags are properly nested, then the document is said to be ‘well-formed’.

By utilizing XML-related technology, the way shared data is structured and presented in each portal screen (e.g., web page) in the portal system network may be manipulated or transformed through the use of a user interface referred to as a “tool box” used for creating, editing, and/or retrieving portal screen content. The retrieval of portal screen content from other web communities and/or databases is done through the use of a pipeline, which implements the data manipulation and transformation commands received by the tool box interface. The tool box interface and pipeline process will be discussed in further detail below with reference to the accompanying figures.

The invention is described below with reference to figures and flowchart illustrations of systems, methods, apparatuses and computer program products according to an embodiment of the invention. It will be understood that each block of the flowchart illustrations, and combinations of blocks in the flowchart illustrations, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions. The inventions may be implemented through an application program running on an operating system of a computer. The inventions also may be practiced with other computer system configurations, including hand-held devices, multiprocessor systems, microprocessor based or programmable consumer electronics, mini-computers, mainframe computers, etc.

Application programs that are components of the invention may include routines, programs, components, data structures, etc. that implements certain abstract data types, perform certain tasks, actions, or tasks. In a distributed computing environment, the application program (in whole or in part) may be located in local memory, or in other storage. In addition, or in the alternative, the application program (in whole or in part) may be located in remote memory or in storage to allow for the practice of the inventions where tasks are performed by remote processing devices linked through a communications network.

The invention will now be described more fully hereinafter with reference to the accompanying figures, in which like numerals indicate like elements throughout the several drawings. Some, but not all embodiments of the invention are described. Indeed, these inventions may be embodied in many different forms and should not be construed as limited to the embodiments set forth herein; rather, these embodiments are provided so that this disclosure will satisfy applicable legal requirements, be thorough and complete, and will fully convey the scope of the invention to those skilled in the art.

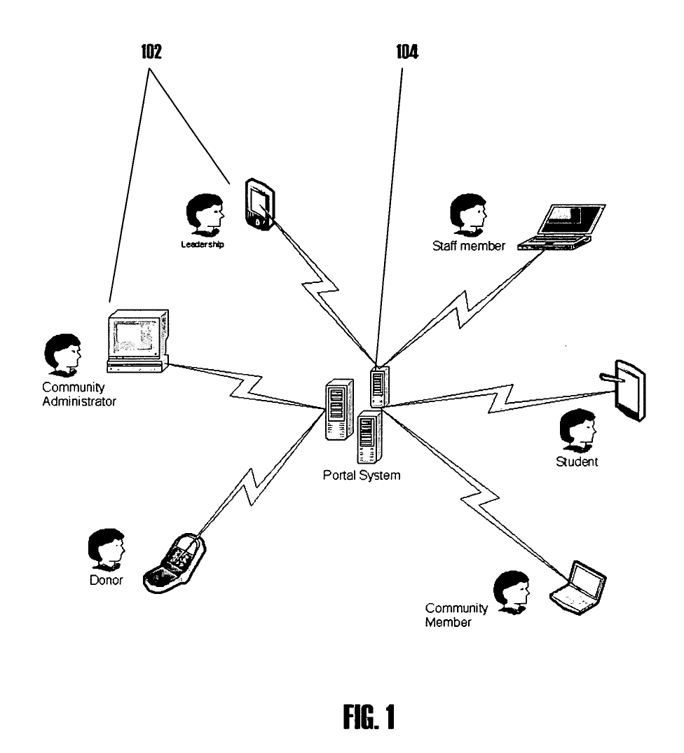

FIG. 1 shows the communication between community members and various exemplary devices and highlights various exemplary types of users 102 in the portal system 104 in accordance with an exemplary embodiment of the invention.

A web community is a collection of members and content. In an exemplary embodiment of the invention, a community has its own home page and one or more other pages associated with it. In an exemplary embodiment of the invention any member of the community may see the community's pages, though secured sections of a community may be implemented requiring a password, log-in, subscription, etc. Moreover, a community may have one or more sub-communities, or belong to one or more super-communities (i.e., communities of communities). In other words, communities may be organized into a hierarchy of inheritance. Thus, a sub-community inherits all the content of its super community. In an exemplary embodiment of the invention, many formal communities would be associated with a super-community, whereas informal, ad-hoc or highest level communities would have no super-community.

Users 102 of the portal system 104 may typically include members of a particular web community, administrators of that web community, visitors of the web sites belonging to a particular web community as well as other users as shown in FIG. 1. A user 102 of the portal system 104 may be a member of multiple communities and customize their personal portal screens (e.g., a user home page) based on the web communities to which the user 102 belongs. In certain embodiments of the invention a community may be password protected requiring a log-in, and even charge a fee for access. The portal system 104 provides users 102 ways to utilize well structured or XML compatible/compliant content to be presented on a portal screen. The content to be presented may be a data set or file (e.g., text or multimedia) and may be stored in a searchable format such that the stored data may be retrievable through as a database query utilizing an address, associated user account, system survey report, etc.

The presentation of content on a portal screen may be manipulated by two main variable components: data structure and the style attributes associated with particular content and/or data structure. The structure of content relates to its general format or data structure (e.g., a list, table, pull down menu, image etc.). The style attributes associated with particular content and/or data structure may include the visual characteristics or attributes imposed on the structure (e.g., colors, font types, font sizes, arrangement, etc.). A data set associated with a particular data structure and specific style attributes may be referred to as “well formed” content or a “well formed” document. Well formed content may be stored in a accessible database or resource center, as a file or the address of the data file may be stored in the database and searchable through a database query, as will be discussed below.

In an exemplary embodiment of the invention, some content may be shared by all community members and other content may be accessible only by a few community members. Such limited access content may be, for example, password protected, require a subscription to the community, be relevant only for community administrators, etc. Members may have a main or home community and may belong to a number of other communities. In an exemplary embodiment of the invention, a member may access all the content (e.g., reports) of the communities to which the member belongs. In other exemplary embodiments of the invention, members may have to enter a unique user name and/or a password to access certain content (e.g., reports) associated with one or more communities. In still other embodiments of the invention, a single sign on functionality may be implemented. That is, after signing on to the portal system all integrated applications are accessible without extra logging in efforts. In an exemplary embodiment, single sign on functionality is implemented by the portal system directing a user's information to a CAS (central authentication service) server. The CAS server inquiries a directory service about the user's information. The CAS server then issues a ticket (e.g., a cookie) to the user. The user then uses the ticket to access the portal system and the portal system verifies the ticket at the CAS server. Other methods of providing secured access appreciable by one of ordinary skill in the art may also be implemented on the portal system.

A user may join or visit a community and decide to become a member. For instance, members may join a community by accessing the community over a web browser or through email invitation, or other methods (e.g., filling out an application/form, paying a subscription, etc.). A member may also have a home portal screen (or home page) within their home community. A member may also customize the content of his home page, as well as the presentation, arrangement, passwords, etc. However, parts of the home page (e.g., the logo and some undeletable content) may always be visible and unchangeable to the member. Further, the member may inherit some content and modules associated with his home page from the member's parent community. The member also may join other communities (and thereby have additional personal pages). In an exemplary embodiment of the invention, a homepage of a community is a page presented to every user joining that community. Parts of the homepage may be inherited from the home page of the super-community. In alternative embodiments of the invention, a community may be a closed community, where the only way to become a member is to be invited by a community member and/or administrator.

As will be discussed below, the user 102 may access the portal system 104, create their own well formed and/or well structured XML content and populate a page with whatever XML content the user 102 wants. The user 102 may also retrieve content that exists on other community sites, and specify automatic structural modification to the retrieved data for placement on the user's own web page (e.g., converting a data set to be displayed in a different data structure such as a list, table, pull down menu, image etc.). The user 102 may further specify the style, (e.g., font size, text color, animation, etc.). The data retrieved and manipulated may also be automatically rendered to be acceptable in various web-enabled devices such as a HTML web browser, WAP enabled wireless device, or any other device specific protocol.

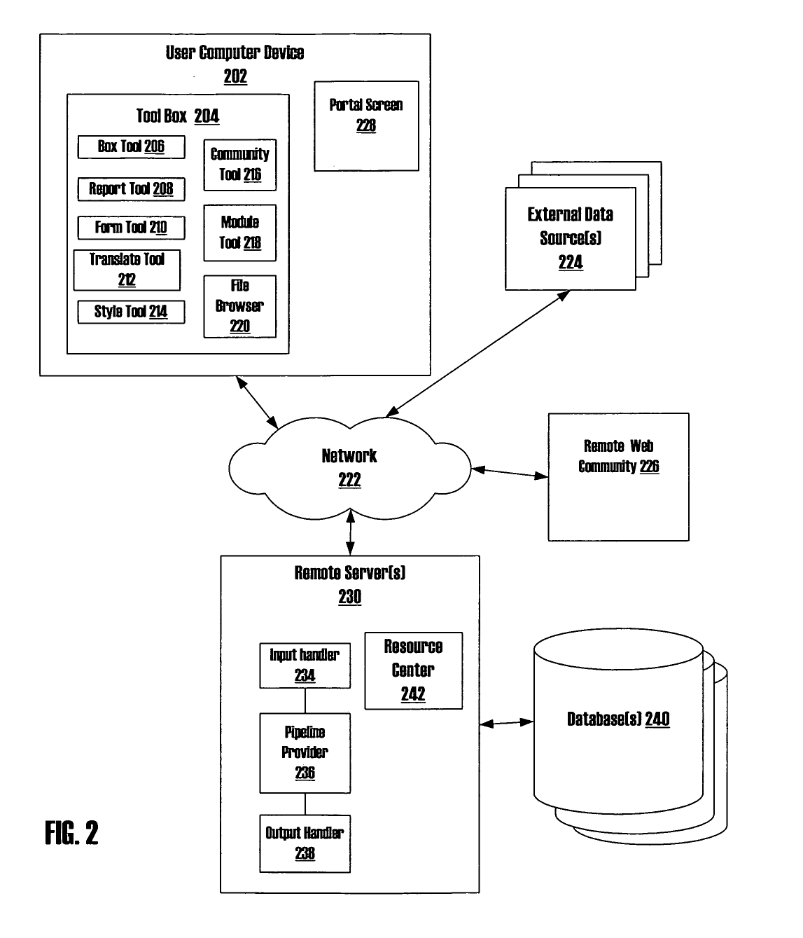

FIG. 2 shows an exemplary embodiment of the overall portal system. The portal system contains a user computer device 202 connected through a network 222 (such as the Internet or another public or private network and may be wired, wireless, or a combination of the two) to remote servers 230, external data sources 224 and remote web communities 226. In exemplary embodiments of the invention, a user computer device 202 may be a computer, laptop, cell phone, PDA, Blackberry, portable WAP enabled device or any other computing device capable of communicating via the network 222. A portal screen 228 is accessible via the user computer device 202. In an exemplary embodiment of the invention, the portal screen 228 may be a web page accessible through a web browser.

In the exemplary embodiment shown in FIG. 2, a user sends a request from the user computer device 202 over a network 222 for a URL (Universal Resource Locator) address (e.g., www.mygcx.org) to the remote server 230. The remote server 230 may verify user identification, password, or other security measures prior to allowing access to the content associated with the URL address. In an exemplary embodiment of the invention, the user is accessing the portal screen 228 (e.g., web page), which may be composed of information from that user's associated community or communities, super-communities (i.e., communities of communities), remote web communities 226, a resource center 242 and other external data sources 224. The remote server 230 responds to the user's request and retrieves the information associated with the portal screen 228 and sends it to the user computer device 202. The portal screen 228 may be part of a user's web community and is accessible to anyone with permission to access the user's associated web community. The data rendered on the portal screen 228 may be stored locally on the user computer device 202, at the remote server 230, or another remote storage location or any combination thereof.

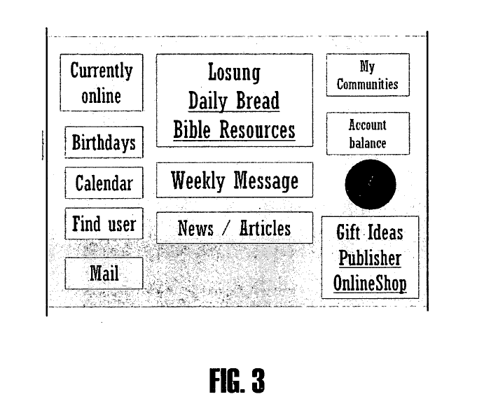

The portal screen 228 is associated with a tool box 204. The tool box 204 is a user interface used to edit, create, and/or add well formed content (e.g., content that has a specified data structure and style attributes) to the associated portal screen 228. The tool box 204 also allows a user to retrieve and manipulate well formed content that exists on another web page, remote web community 226, remote database 240, or other external data sources 224. In an exemplary embodiment of the invention well formed content may be data in HTML, XML, or similar formats. When the tool box 204 interface is called up from a portal screen 228 by a user, the tool box 204 is used to create or modifying portions of the portal screen 228. These individual portions of the portal screen 228 are known as boxes (or div tags). A box is a framed area on a portal screen 228. A box may be any size and may even makeup the entire portal screen 228. Multiple boxes makeup the layout of a portal screen 228. An exemplary layout of a portal screen 228 is shown in FIG. 3 discussed below. A box may contain fixed text or image (e.g., a community's logo), information extracted from a database or from a remote data source, links to other portal screens, controls (buttons, etc.) for a particular function (including but not limited to controls for screen customization like minimize/restore, delete, move up, move down, etc.) and other content appreciable by one of ordinary skill in the art.

The content associated with the boxes is displayed on the portal screen 228 as well formed HTML or XHTML. Therefore, what is displayed on a portal screen 228 (or web page) is an aggregation of boxes where the boxes each have an associated report and an URL that is associated with the report. A report is the composition of different pieces of content to be presented in a box. A report may include files, fragments of files, database queries and other information sources. Typically, reports are accessible by community members and in its sub-communities, and reports may be sharable (i.e., accessible by members of all communities or other system users). Reports may also identify content from external data sources 224 to be retrieved and manipulated. Some of these external data sources 224 may be in RSS/Atom format, or alternatively, an MS SQL server may provide them in data-centric format. Well structured XML content may be data-centric, while HTML is presentation-centric. Data-centric documents are documents that use XML as a data transport. Data-centric XML data is generally for machine-to-machine transfer of machine readable data. Data-centric XML content may be structured according to a particular application. Document-centric XML data is usually human readable and may contain some markup to understand the data (e.g., text). Such interface components may require a conversion to be a well formed document prior to being displayed on a portal screen 228. In an exemplary embodiment of the invention, the efficiency of the portal system performance improves by utilizing data-centric XML content.

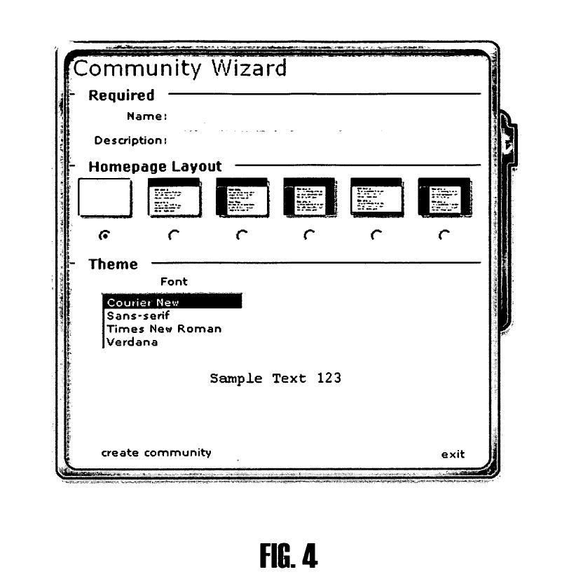

The tool box 204 may be used by any level of portal system user (e.g., community member, community administrator, community web designer, etc.). The tool box 204 contains a set of tools for developers. Each tool accepts inputs or selections from the user. Some of these tools require no technical knowledge, while others may as discussed below. Tool boxes 204 also serve community administrators to create communities, pages, boxes, reports, forms, etc. Some tools may require more technical knowledge used by module developers, while other tools may be used only by technology developers with intense knowledge of the portal system's internal structures. In an exemplary embodiment of the invention the tools of the tool box 204 are user interfaces or wizards (i.e., user-friendly configuration interfaces which guide a user with little knowledge of HTML or the system's inner workings to perform a particular customization or task). An example of a wizard interface is shown in FIG. 4, discussed below. In an exemplary embodiment of the invention, the interfaces and wizards of the tool box 204 may be used to generate a connector to an external application associated with that interface and/or wizard. Additionally, through various development tools such as “on-line” WYSIWYG (“what you see is what you get”) editors and other types of user-friendly interfaces, varying levels of technical knowledge can create and/or manipulate data through the use of the tool box 204. WYSIWYG editors are graphical web pages builders that enable the building of web pages without the need for a user to have a working knowledge of HTML through the use of user-friendly graphical interfaces. WYSIWYG editors provide a user the option of formatting text, adding colors, adding images, inserting hyperlinks, as well as customize additional features associated with a web page. Hence, in an exemplary embodiment of the invention the tool box 204 utilizes WYSIWYG editors. The graphical interface of WYSIWYG editor allow a user to insert text, graphics, tables, bullets and more to assist users in building HTML pages. The tools in the tool box 204 may also allow for automatic customization, for example, modifying the content display on a web page based on monitored web-surfing behavior. The actual retrieval and modification of data occurs in what is referred to as the pipeline process discussed in further detail below.

Thus, a community administrator or community member may use the tools in the tool box 204 to create new content for his community. First, the community administrator selects a tool from the tool box 204, which presents a form (or user interface) to the user. The user interface contains input fields forms (like a text field or a button) for a user to enter data. The user interface also contains controls (e.g., “submit” or “clear”) for assisting in filling in the input fields. Content inputted into the form may be stored in a table in a database 240 or resource center 242. The stored data inputted into the form may be used to generate a report, which represents the stored data. Other tools in the tool box 204 may utilize these reports to manipulate the data in a variety of different ways depending on the tool selected. In the exemplary embodiment of the invention shown in FIG. 2, when a user is creating or editing a portal screen 228, the tool box 204, allows users to create boxes (div tags) and set the report to be associated with that box. The report may be associated with a community to which the user is a member, shared content of another community, or external URLs. Additionally, a user may access the tool box 204 to add content to a portal screen 228. In an exemplary embodiment of the invention, the user may access the tool box 204 through a portal screen 228 and create a new box. The creation of a new box may be implemented through the use of the box tool 206 located in the tool box 204. Then the user would access the file browser 220 to search the resource center 242 for the desired report. In an exemplary embodiment of the invention, the user may search under the community name and/or the portal screen 228 name and view the list of reports associated with that screen to find the desired report. The user would then select that URL to be retrieved through the system's pipeline and be associated with the box created on the user's portal screen 228.

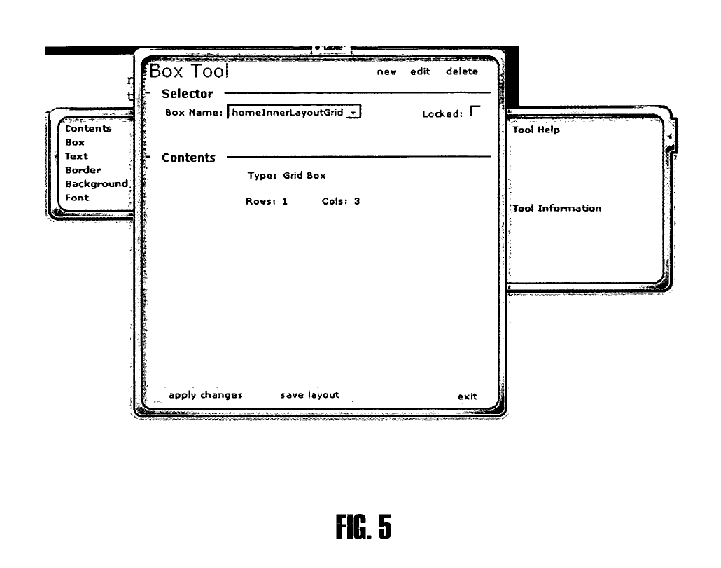

In an exemplary embodiment of the invention, the tool box 204 contains numerous tools such as the box tool 206 (e.g., for creating boxes on a portal screen 228 where well formed content is to be associated with), report tool 208 (e.g., for customizing structure and style data to be associated with the box), a form tool 210 (e.g., for defining buttons, input boxes and interactive items on a portal screen 228), a translate tool 212 (e.g., for translating the tool box 204 and other portal modules into other languages), a community tool 216 (e.g., for creating communities), and a style tool 214 (e.g., for defining the appearance attributes of portal screens 228). An exemplary box tool interface 206 is shown in FIG. 5, as discussed below.

In an exemplary embodiment of the invention the style tool 214 may be an interface capable of transforming data in multiple levels. The HTML display structure is considered the first level of transformation which changes the data from looking one way versus another. As an example of altering the HTML structure, the original report data may be structured in a tabular form with rows and columns while the user wants the data in a list view, or the user may want that data as a link in a calendar grid, while another may want the data in a chronological list. The second level of transformation is the file display layer. For example, the style tool 214 may be configured to use cascading style sheet (CSS) attributes to set the weight and color of the font associated with the data to be displayed. It is well known to one of ordinary skill in the art that such style sheet attributes define how to display HTML elements (e.g., font type, size, color, etc). The user makes choices and can see those results on the screen. An example of altering the style of the report data to be retrieved would be altering the font size, font type, color, associated animation, etc. of the data to be retrieved. For example, if two users had the same report with the same HTML structure on their respective portal screens 228, one user could specify the text be bold and black, while another could specify italics and blue.

In alternative embodiments of the invention, the tool box 204 may also include a number of modular tools and form tools 210 for automatically converting the data to be displayed in a PDF document, or running the data through language translation software prior to posting, etc. A module tool 218 may act as a packaging tool that assemblies the reports, forms, data structures, etc., so that someone can share their module with other communities.

A module may be an internal or external web application. For example, a module may be a server side program that a user communicates with through a web browser using Internet Protocol (IP). In other embodiments of the invention, an internal module may be a collection of, e.g., database tables, reports, forms and screens. A community administrator can create a simple module with the tools from the tool box interface 204. Further, a module can be easily customized into a new module through the use of the tool box 204. However, more complex modules may require programming capabilities to be created by the user.

External modules are software installations, not part of the portal system, that can interact with each other. In alternative embodiments of the invention external applications may be integrated into modules that are part of the portal system. In accordance with an exemplary embodiment of the invention, the portal system may connect to an external application (e.g., a financial management application of a local business). In order to connect an external application an XML interface must be created to handle the external data associated with the specific external application. This may be communicated to the portal system through a web server client. The communication between the portal system and external databases 240 may be implemented synchronically through a web service client or asynchronically, where changes are stored locally and regular updates occur (e.g., every 24 hours). The module may be customized, modified or created by the module tool 218 of the tool box 204. Examples of various modules may include a help module (information of present features), page customization module (for changing page outline, personalization, etc.) and search module (web search of all web sites connected to the community). Other modules may include orientation (e.g., creating and managing links on a page), various portal functionalities (thread discussions, calendars, news, mail, instant messaging, Voice-over-IP, blogs, pictures, web shopping, video conferencing, etc.) and member locators (finding members by attributes, birthday, guestbook, etc.).

In another embodiment of the invention a tool box 204 may also contain a form tool 210, where a primitive version of a form (i.e., a user interface) may be used to input data that may be used to create a more sophisticated user interface (e.g., more data entry fields, more specific data entry categories, etc). In other words, a more complex or more job-specific tool may be created and added to the tool box 204. The form tool 210 has the additional functionality for creating a new database location where the data of the newly created form are going to be written. The form tool 210 allows you to make form elements (input box, submit button, etc.). After specifying the requirements in the form tool 210, the user can apply the changes and the tool box 204 displays it on the portal screen 228 and the user can set attributes for the text. In certain embodiments of the invention, the tool box 204 can also accept and execute programming code to create and/or manipulate content on a page. Hence, community administrators or members can also customize their associated tool box 204 by adding more form tools 210, module tools 218, style tools 214, etc. to provide additional data transformation or manipulation of content associated with a particular portal screen 228 or community. For example, a community in Germany, can create a module tool 218 option in their tool box 204 to translate modules into German. As another example, a preview function may be added in the tool box 204 to preview data before posting to a portal screen 228.

In an alternative embodiment of the invention, entire portal screens 228 (e.g., web pages) may be created by a community administrator through the use of a page tool (not shown) located in the tool box 204. In an exemplary embodiment of the invention the page tool provides a template that includes pre-selected structure and style attributes and particular content to be included in a new portal screen 228. The portal screen 228 created by the page tool may itself be stored as a report. Thus, the entire page may be accessible and usable by other community members or other communities that have access to the stored report. In alternative embodiments of the invention, it is possible to build templates of community portal screens 228 through the use of off the shelf web design software. In doing so, the system operates like an HTML editor, however the portal system still allows a user to set attributes for any kind of XML document. In other embodiments of the invention additional tools may be used such as a table tool (for creating databases and/or to create structured data such as tables for text files) or a rule tool (for defining input constraints and page sequences).

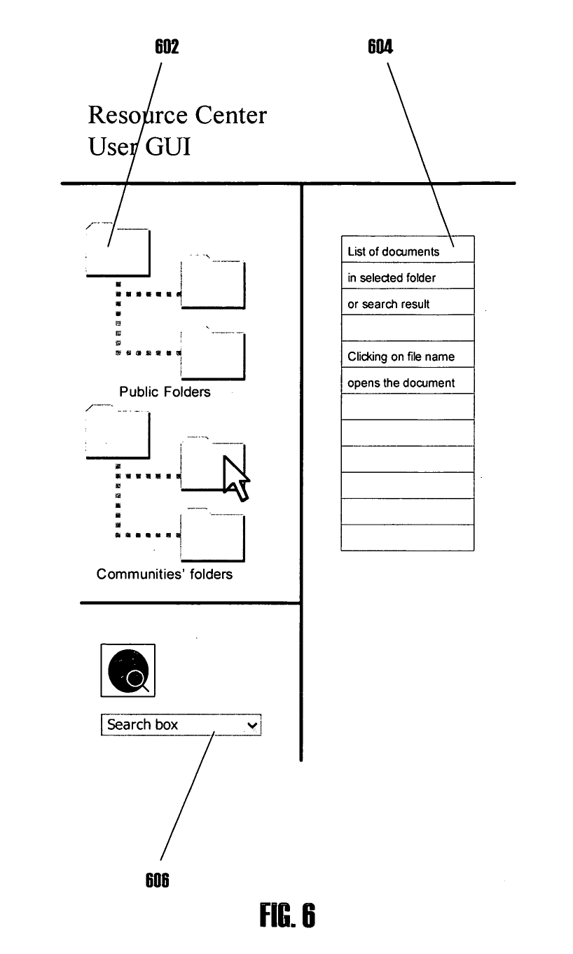

In the exemplary embodiment of the invention shown in FIG. 2, the tool box 204 also includes a file browser 220 for locating previously created reports associated with the same or other communities of the portal system. In an exemplary embodiment of the invention, the file browser 220 accesses the resource center 242 of the remote server 230, or alternatively, the file browser 220 may access external data sources 224 to locate other well formed content, or databases 240 accessible by the remote server 230. An exemplary file browser 220 is shown in FIG. 6, discussed below. The external data sources 224 may include web pages located on the Internet outside the portal system.

The resource center 242 is a searchable database or collection of databases located on one or more remote servers 230 running portal system software. In an exemplary embodiment of the invention the resource center 242 is located on a remote server 230 which stores URL links to previously created reports from other web community administrators, community members, other remote web communities 226, etc. In an alternative embodiment of the invention, the resource center 242 may be located at a remote location accessible by the sever 230. The resource center 242 may include a collection of all reports, documents and/or modules handled by the portal system, and may be organized by categories, file name or other means to allow for organized searches for well formed content desired for use by the user. The files stored or referenced by the resource center 242 may be text documents (e.g., HTML or Word), media (e.g., picture, music or video) or other files. The content may be aggregated into a document or module or can be browsed (e.g., according to categories or to the formal community structure) or searched (e.g., by keyword). The content stored in the resource center 242 may be retrieved by a database query. In an exemplary embodiment of the invention, a resource center 242 may belong to one or more communities, where the community administrator defines the structure of the resource center 242 as well as who and how it can be manipulated. A database wizard may be provided to help non-technical administrators navigate the resource center 242. In an alternative embodiment of the invention, the resource center 242 may provide only the address or link to the report, document or module requested by a user and the actual well formed content may be stored at another location. Once the user has made the desired selections using the tool box 204, the box's associated report contains all the user's selections. When the user requests the posting of the transformed report data located by the resource center 242 to the portal screen 228 the data to be retrieved is located and copies of the data are transformed and manipulated as specified by the user's selections made with the tool box 204 (which are contained in the report associated with the box). The operation of the retrieval process will be discussed in further detail below.

The tool box 204 user may also search external data sources 224 (e.g., other websites) over the Internet and capture well formed and/or well structured XML content. For example, an XML source or feed from a third party web site may be captured, as there is an URL descriptor for that particular XML source or feed. For example, a Really Simple Syndication (“RSS”) feed is a well structured XML application, so it could be retrieved, through the pipeline and/or restructured/restyled, even though the data (i.e., the RSS feed) comes from a source that is not part of any community associated with the portal system. Another example is where a user chooses a URL associated with a particular news article located on a particular web site. However, the HTML structure that the user may want to have for that particular data on their portal screen 228 may be completely different than the HTML structure than that the original report. Thus, once the user has the URL (i.e., report) for the data to be associated with a box on the user's portal screen 228, the user may retrieve the data and use additional tools located in the tool box 204 to manipulate the HTML structure of the data to be retrieved as well as one or more style attributes of the retrieved data.

In an exemplary embodiment of the invention, the remote server 230, which may be running on a Linux operating system, is an Apache web server. Apache is a freely available web server that is distributed under an “open source” license. Version 2.0 runs on most Unix-based operating systems (such as Linux, Solaris, Digital UNIX, and AIX), on other UNIX/POSIX-derived systems (such as Rhapsody, BeOS, and BS2000/OSD), on AmigaOS, and on Windows 2000. In an exemplary embodiment of the invention the portal system software operates on a Linux operating system which utilizes its own file system as well as a MySQL database, such as the database 240. The database 240 can either be local or remote to the server 230 and houses the portal system software and/or the stored resource center 242 content. Each request received from a user computer device 202 will be claimed by and “handled” by a single handler. Handlers and filters are two different types of input and output modules. A handler generates the response sent back to the client. Filters can inspect this response and optionally change the content in various ways including inserting new content, encrypting the content, compressing the content or group the content differently.

In an exemplary embodiment of the invention, associated with the operating system is the MySQL database 240 and a filing system communicating with the output handler 238 and the input handler 234. The output handler and the input handler 234 (as well as the web service client module associated with the output handler, which allows for communication with an external web service) makeup the runtime component of the portal system. In an exemplary embodiment, the runtime component has been programmed in Perl. The input handler 234 receives data from a form, which is part of a larger module. The module may include reports formatted for the portal system, reports in an external format, tables, pages or Java Script. Reports, forms, tables, and pages can each be created by a corresponding tool of the tool box 204. The output handler 238 serves different type of clients such as an HTML Client or possibly a PDA, WAP, or web service client. The output handler 238 and the input handler 234 on the back end share the context object, which contains context information including information about the actual user, his profile (e.g., profile object, his community, his last request, etc.). The output handler 238 activates one or more providers such as the screen provider or report provider, which output to the pipeline provider 236. Moreover, the report provider gives raw XML data to the tool box 204 which transfers raw XML data to the input handler 234.

The portal system is composed of layered architecture. On the lowest level is the runtime component with input and output handlers 234 and 238 that communicate with a database 240 and/or the local file system on a remote server 230, or external data sources 224 accessible over a network 222. The input handler 234 and output handler 238 share the profile information of the portal users (e.g., their community, their profile, their last request, etc.). In the exemplary embodiment of the invention, the runtime component is programmed in Perl and is connected to a MOD_PERL module of the remote server 230. The lowest level of the architecture also has an XML/XSLT pipeline provider (Apache filter) 236, as well as secured access components.

The runtime component is connected to the MOD_PERL module of the Apache web-server application running on the operating system. In exemplary embodiments of the invention, the MOD_PERL module is also in communication with the authentication security module to enable secured communication. The Apache-Filter is an XSLT processor serving the portal's functionality expressed in XSLT documents. Generally, an Apache filter examines and sometimes modifies request data flowing into the remote server 230 from the client as well as the response data flowing back from the remote server 230 to the client. Another Apache module is the authorization module, which is connected with the Authentication Server. The authentication server provides authentication services to other systems on a network 222. Users and network servers alike authenticate to such a server, and receive cryptographic ticket's. The tickets are exchanged to verify the other's identity.

On top of the lower level are tools community administrators (or other web developers) used to build pages for aggregating data, reports (e.g., data outputted from sources like databases 240, resource centers 242, XML/Xpath sources, URL's, web services, or other external data sources 224), forms (for entering data), rules determining the flow of processing, and tables for storing data. The resource center 242 stores all the data sets utilized by any of the portal screens 228 for any community associated with the portal system. The file browser 220 queries various search fields of the resource center 242 including community name, portal screen 228 name, report name to locate the report desired for use by the user. Once the desired data set has been located and the user has made her tool box 204 selections as to how the desired data set is to be transformed or manipulated, then the desired data set is requested by the user. The tool box 204 then generates a report for the requested data set. The report identifies the data set as well as any modifications to the data set that result from the user's tool box 204 selections. The report is handled by an input handler 234, which prepares the report to be handled by the pipeline provider 236 by locating the requested data set through its associated URL.

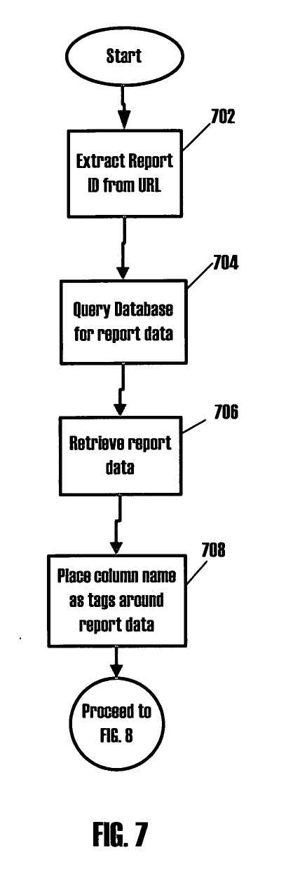

The pipeline provider 236 comprises a three step process. In the first phase, the desired data set is retrieved from the resource center 242 or remote database 240 depending on where the desired content is actually stored and then converted back to its original well formed data-centric XML structure. The second phase transforms the structure of the desired data set to the structure specified by the user's tool box 204 selections. The third, and final, phase transforms the data set based on the style (or appearance attributes) specified by the user's tool box 204 selections. The third phase may also convert the data to be accurately displayed depending on the devices (e.g., WAP enabled wireless device, PDA's, etc.) on which the user specified the content should be accessible. The three phases of the pipeline process are discussed below with reference to FIGS. 7-9.

Finally, once the pipeline provider 236 has completed its data conversions the output handler 238 sends the converted data to be rendered on the portal screen 228 of the user's computer 202. In an exemplary embodiment of the invention, the output handler 238 is capable of rendering the data in a form compatible with several types of output devices such as an HTML browser, or WAP enabled device, PDA, web service client, etc. The requested data is presented on the portal screen 228 having been transformed and/or manipulated according to the user's specifications entered into the system through the use of the tool box 204. In an alternative embodiment of the invention, the response to the user request may also be configured to utilize only the first two phases of the pipeline provider 236. If this mode is chosen then the user's portal screen 228 is not automatically updated, however, the requested transformed data appears in the user created box, and the user may then manipulate the data transformation further. The user may then accept the changes and apply the changes and post the data on the associated portal screen 228.

FIG. 3 shows a layout of an exemplary portal screen. The content of the screens may comprise standardized document structures that web browsers would use. FIG. 3 shows numerous boxes such as Calendar, Mail, News Articles, Account Balance, etc that are associated with data that is displayed on a specific portal screen. Even the pie chart displayed is associated with a box (i.e., div tag). In other embodiments of the invention, video files (MPEG, etc.), audio files (mp3, etc.) and/or streaming video or audio files may be associated with a box. In an exemplary embodiment of the invention, the boxes are created in XHTML, which is XML compliant HTML.

FIG. 4 shows a screenshot of a wizard for community creation in an exemplary embodiment of the invention. The Wizard leads a user through a series of prompts (or interfaces) to create new components of the portal system or create content to be utilized on the portal system. A wizard offers templates to choose content and its associated presentation information. A community wizard, as shown in FIG. 4, is a module supporting the creation of a community that allows for a portal community to be created with relatively little knowledge as to the portal system's functionality. Through the use of these wizards a user may populate the community with a set of modules (e.g., a message board), create a mailing list, invite/add new members assist in searching templates and utilizing another portal system user's data content as well other community functions.

FIG. 5 shows a screenshot of the box tool of the tool box interface. As shown in FIG. 5, a box is given a name and a specified content structure (e.g., “GRID Box”). The box can be associated with numerous structure types depending on the type of data which will ultimately occupy the box (e.g., text, image, etc.). Once a tool box user has created a box, the user may create a report to be associated with that box, or the user can associate an already existing report with the newly created box. If the user wishes to create a new report for the box, then the user may access a report tool in the tool box and enter the report to be associated with that box, or the user may access the resource center or other database to associate a particular report with the box. If the user wishes to use a report that has already been created by either another community member, another community, or one found on an internet web page, the user can access a file browser to look up the particular report the user wants to associate with that box. In alternative embodiments of the invention, the user may access a report only if they are authorized to access that particular report. Such embodiments may encrypt reports, require password log-ins, or some other secure means to prevent unauthorized access to particular reports. Further, those secured reports may only be accessible to a particular type (or class) of user such as community's members, a particular level of community member, community administrator, users that are subscribers, etc. The file browser can search locally stored files for reports or it can search and retrieve remotely located reports. In an exemplary embodiment of the invention, the file browser accesses the resource center to access remotely located reports. When the reports are created, the report tool allows the user to name the report and to include a brief description. For example, a report can be called “NEWSFEED.” The report describes the data set or information, not its display structure and style (i.e., look and feel attributes).

FIG. 6 shows an exemplary embodiment of the file browser accessing the resource center. Essentially every portal screen in a community can be named and then it can be looked up in the resource center. Alternatively, the user can find the particular reports the user wants by searching fields such as the creator name, report name, resource name, etc. Once the desired report name is located in the resource center, the user can apply the report to a particular box or screen that the user is building with its use of the tool box. In an exemplary embodiment of the invention the listing 604 in the resource center is the name the creator gave it. Associated with that name is the URL descriptor or resource descriptor with which the data set is retrieved. In an exemplary embodiment of the invention, the content has to be in well formed XML or similar well formed tagged document to allow for manipulation. It is desirable that all communities structure their data in the same way to ensure transferability and for successful manipulation of that data.

The resource center stores the various communities' report data. Images may be stored as binary objects, Javascript is stored as text. Other means of data storage would be appreciated by one of ordinary skill in the art. For example, the resource center can be configured to store the data in multiple servers, or alternatively, the resource center may be a look up table, which then goes out and retrieves the data from wherever it may be stored. In an exemplary embodiment of the invention the report id is URL-based, which is a web addressed scripter of that resource. In the resource center, some communities may label some of their stored reports as private and others public. While others may charge a fee to someone wanting to use certain reports others have created or charge a fee for a variety of other actions such as joining a community, etc.

One way a user can locate a report name is to view the source of a page and look in the box (e.g., div tag) to see the name of the report, or the user can browse (search) 606 the resource center utilizing various fields including which community the report is associated with, the portal screens associated with that community, and the report names associated with a particular portal screen. In an exemplary embodiment of the invention, every community has a hierarchical arrangement of folders 602. A folder 602 includes other folders and links. A link points to resource center content, such as a document. The physical location of the documents is irrelevant, as typically only the addresses (URL's) are contained in the listing 604 of the resource center. In exemplary embodiments of the invention, the resource center contains an (unstructured) document container for documents not contained elsewhere online. Documents are either public or private to particular communities or community members/administrators.

A detailed discussion of the steps of transforming an original XML document into HTML (or presentable XML) before sending it to the user is discussed in further detail below with respect to the pipeline process shown in FIGS. 7-9. The pipeline process is a process for retrieving the document data, carrying out the transformation of an original XML document into the requested HTML (or presentable XML), and sending it to the user for display on a portal screen. An XSLT pipeline comprises an XSLT processor and a set (or series) of XSLT documents, which contain or reference the transformation rules describing step-by-step transformation of the original XML into an HTML or XML document. An XSLT processor is a program that reads an XML document, transforms it, and produces another XML document. In an exemplary embodiment of the invention, the XSLT processor may be an Apache filter and a component of the Apache web server. In the exemplary embodiment of the pipeline of the invention, the original (or input) XML document includes references to the series of XSLT documents. The XSLT processor transforms the original XML data according to a first XSLT document; the result is an (intermediate) XML format. This is going to be transformed according a second XSLT document, then a third, etc. However, in an alternative embodiment of the invention, a transformation may change the list of referred XSLT documents (e.g., adding some new ones or deleting some from the list), thus the pipeline is not static.

The pipeline is able to process not only data-centric XML, but also document-centric XML and presentation-centric data as well. In alternative embodiments of the invention, XML data may trigger external applications maintaining their own external data. An XML interface (e.g., web service) accesses this external data and allows the web service client to read and/or write the data and present the data on a web browser. In an exemplary embodiment of the invention the last transformation in the pipeline process applies to styling, so the last transformation is described by an XSL document. In alternative embodiments the styling is processed on the client side utilizing CSS style sheet attributes.

In an exemplary embodiment of the invention the hardware and software used for implementing the pipeline functionality is a server running Apache web server software with a MOD_PERL module and Apache XSLT filter to handle the incoming request. In an exemplary embodiment of the invention, the MOD_PERL module includes the input handler component and the output handler component. The input handler is used for storing data, and the output handler is used for retrieving data from the location in which it was stored and preparing the retrieved data for the pipeline process (e.g., converting the data to XML format, if necessary). Additional data (including XML data) to be utilized during the pipeline process may be fetched by either the MOD_PERL module or the Apache XSLT filter from the MYSQL database running on either the same hardware as the Apache web server or alternatively, the web server and the database may run on different servers capable of communicating with each other.

In accordance with the exemplary embodiment of the invention described in FIGS. 7-9, the pipeline is divided into three phases. The first phase is content aggregation, where content is transformed according to abstract types (or categories) of data structures (also referred to as a data “stereotype”) by utilizing XSL/XSLT on the server resulting in device independent HTML/XML. The second phase is structure assembly, where the device independent HTML/XML is transformed by data structure and/or style attribute information. All structured XML is going to be collected through XSLT calls in the second phase. After determining the platform type (e.g., HTML, PDA, Web service, etc.) associated with the device on which the requested data is to be rendered a further XSLT call generates platform dependent data. There may be more XSLT calls included in the process reaching back for more stereotypes repeating phase one for more requested report data. After collecting all platform dependent data the server side rendering takes place through XSL, producing the server output in HTML. Finally, the third phase is client side rendering, where CSS (Cascading Style Sheets) are utilized to map an XML element into a single display object that is compatible with the requesters display device. The result may then be presented on the user's display. Cascading style sheets attributes are often dependent on the client device on which the data will be presented (e.g., browser, PDA, cell phone, web service, etc.). The details of the operations occurring in the three phases will be described in further detail below with reference to FIGS. 7-9.

As shown in FIG. 7, the first phase of the pipeline process deals with content aggregation, which is retrieving the report data from the resource center (or wherever the relevant report data is stored) and preparing the data to undergo structural and/or stylistic transformation. Phase one is the only phase that deals with the requested report's definition (e.g., URL). The report definition may identify a screen name, community, and page, which describe where the content is coming from, as well as a report name, which identifies the content to be retrieved. The report definition may also identify the output abstract data type. The report name included in the report definition differentiates what on that screen is requested but the other report definition information is the same for the other content on that screen.

As shown in FIG. 7, the first step in phase one of the pipeline processes is step 702, which extracts the report name from the URL referring to that report data. Next, step 704 queries the resource center database for the report associated with the requested report's name. The pipeline fetches a result set from the database (or other data sources) according to report data associated with the content being retrieved. To do this, the report associated with the user's data request can be turned into a SQL query that gets the desired content from the resource center database. To retrieve the requested report data, the report is looked up by its associated community and name. Hence, the use of a compound key may be necessary. In the compound key, one key is a community name and the other is a report name, both of which are contained in the URL. For example, a URL of mywebsite.org/screen/community name-page/reportl. The community name of that URL comes from the community of whatever report the user requested. The report name identifies the data set and its associated structure and style attributes. Once the data is located step 706 is invoked to retrieve the desired report data from the resource center (or, alternatively, an external data source). In an alternative embodiment of the invention, the XML data sets may be retrieved not only from the database, but also from SOAP (Simple Object Access Protocol) calls or other web applications appreciable by one of ordinary skill in the art. SOAP calls are ways for a program running in one kind of operating system (such as Windows 2000) to communicate with a program in the same or another kind of an operating system (such as Linux) by using the HTTP and XML as the mechanisms for information exchange. In other embodiments of the invention other access protocols may be used to retrieve XML data such as Representational State Transfer (REST) and Remote Procedure Call (RPC), etc. REST is an approach for retrieving content from a web site by reading a designated web page that contains an XML file that describes and includes the desired content. RPC is a protocol that a program can use to request a service from a program located in another computer in a network without understanding network details.

Next, step 708 is invoked and the output provider identifies the abstract data type (e.g., “list”) from the report data, so the retrieved data may be transformed into XML according to the abstract data type. In an exemplary embodiment of the invention this is done by taking the report data in the database and wrapping the desired report data's associated column names around the desired report data as XML tags. At this point, the XML tags surrounding the requested data are as they were during setup by the original creator of the requested report. For example, if its column is “last names,” then the “last name” value gets wrapped in last name tags. After in the first phase, a device independent XML document has been produced.

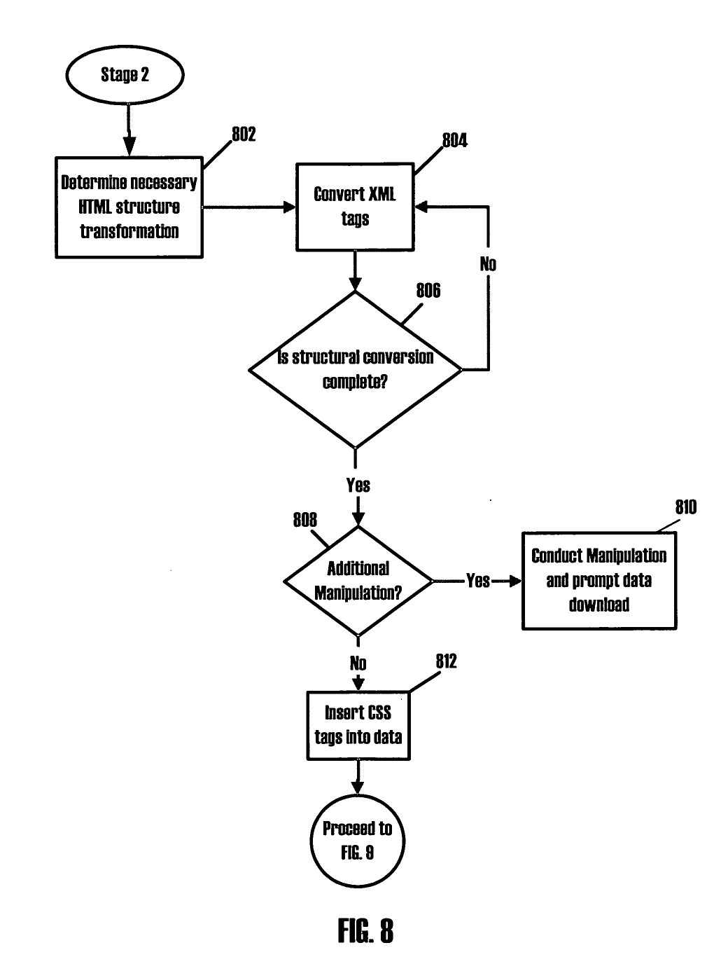

FIG. 8 shows the flowchart of phase two of the pipeline. In the second phase, the Apache web server software passes the abstract XML data to a filter mechanism, which is the XSL processor. The second phase involves identifying the desired device type (e.g. HTML, WAP or PDA) according to user data and translating the abstract XML data into device specific tags (markups). The original device type associated with the retrieved content also is identified and all device information (e.g., device types) extracted from a database. The result may be a segment such as an HTML segment, a WAP segment, a PDA segment or other device dependent segments. According to the device type segment, abstract data types can be translated and device specific mark-ups (typically UI controls) generated. As shown in FIG. 8, the second phase of the pipeline starts at step 802 which determines the necessary HTML structured transformations that must occur to achieve the user's desired data structure to be associated with the report data. This step is completed by retrieving the structure parameter (also referred to as the structure type or structure “stereotype”) specified on the report associated with the user's requested data and applying the XSTL (the XML style sheet) to the report data's associated tags to transform the desired report data into the structure the user requested. This transformation is done by invoking step 804 to convert the XML tags that are wrapped around the report data based on the output the user desires.

For example, a list structure (e.g., “ULLI”) tag can be converted to a table format by changing the tag structure to form ULLI to a table structure tag (e.g., “TRTD”). Other transformations may require several intermediate transformation steps to get to the final desired structure. Thus, step 806 directs the process to repeat step 804 until the structural conversion of the data is complete. For example, if a user wanted to take an instant messenger entry and make it a title hyperlink for an article, multiple transformations would need to occur. First, the instant messenger tags must be converted to a message board tag, then converted again to an HTML structure and so on, to further manipulate data subsets such as creating titles, etc.

After a transformation step is complete the data can undergo further manipulation in step 808 by exiting the pipeline process through the output handler for further processing through various software routines. This further processing may be specified by the user's report generated by the user's tool box inputs and selections. For example, converting the dataset to a PDF document qualifies as the type of transformation requiring an exiting of the pipeline process to perform the necessary external applications. In that instance, rather than match those tags and transform them into another HTML structure, step 810 is invoked to send the data to undergo other processing and then sends the results to the user or prevents the results to the user as a separate download. This additional processing is done by exiting the pipeline process. The output handler utilizes XSTL and XSP (extensible style sheet processing), which send the data out to be manipulated by C code or Java programs or other software programs designed to manipulate the data set (e.g., convert it to PDF format). Once that process is complete, the XSL sends an HTML message to the user saying the process was a success and may prompt the user to start downloading the PDF document or automatically transmit the PDF document to the user. Once the structural conversion is complete, the last step of the second phase of the pipeline process, step 812, builds CSS tags, for use in phase three to convert style attributes associated with the data based on those selected by the requester of the data. After in the second phase a device dependent XML document has been produced, remaining variables (e.g., date) should be replaced by their values, in order to present the result to the user.

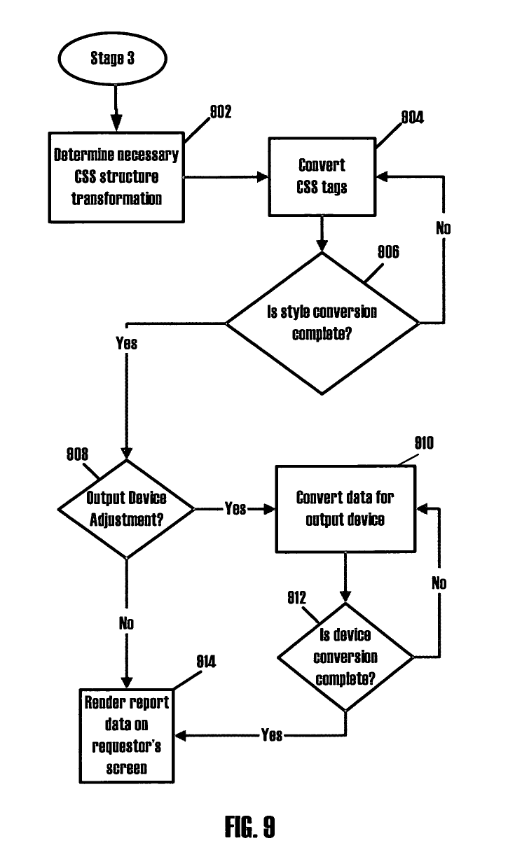

FIG. 9 shows the flowchart of phase three of the pipeline. In phase three, variable substitution is conducted (e.g., name, date/time stamp, community membership, pager information, etc.) and the data is rendered for display. As shown in FIG. 9, the third phase of the pipeline applies the CSS style sheet attributes to the box to make any device specific or style adjustments to the data (which may have been designated by the requester, or alternatively, established by the WYSIWIG interface features of the tool box). In phase three, the process of phase two is repeated; however, the conversions deal with CSS tags and not XML tags or HTML structure. In phase three, step 902 determines the necessary CSS style sheet attributes necessary for the user's requested style attributes to be associated with the now structurally converted report data to start the conversion process. In an exemplary embodiment of the invention, the requested CSS style sheet attributes are associated with the user's screen name and box name to be associated with the report data.

Once the necessary style transformation has been determined, step 904 is invoked to begin the conversion of the CSS tags associated with the desired report data. In the second phase of the pipeline when the HTML document is put together, link tags which may be CSS style sheet attributes are also inserted. The final display layer (i.e., style tool commands) is pulled for the screen and the CSS style sheet attributes are applied to the box that is being created. Therefore, in the third phase of the pipeline process the output type is now CSS-based and a process similar to the phase two process for HTML structural conversion is conducted for CSS style sheet attributes conversion. Thus, the transformation is not involving HTML tags, rather its making an CSS style sheet. Hence, step 904 converts the tags, to ones which call the CSS attributes that are particular to the desired report data's style attributes. Step 906 directs the process to repeat step 904 until the style conversion of the data is complete. In alternative embodiments of the invention, steps 902, 904, and 906 may operate the same way for non-CSS browsers like many WAP enabled PDA's, cell phones, and various other portable devices.

Next, step 908 determines if the CSS attributes needs any conversion for formatting the data to be rendered on a particular output device. In step 910 the style data would be adjusted, in part, based on what output device on which the desired data will be rendered. For example, the additional style conversions may need to be made when publishing data to a hand held device versus publishing that same data to a browser. As a result, the final display layer adjustments handled by the third phase of the pipeline may be output dependent and screen dependent (e.g., rendering the report data on an HTML web browser or a WAP enabled portable device). Step 912 directs the process to repeat step 910 until the style conversion for the formatting of the desired data for a particular output device is complete. When the third phase is completed, desired report data has been fully converted as specified by the user and step 914 sends the fully converted report data to the user's device through the output handler.

In an alternative embodiment of the invention, the first two steps of the pipeline can be executed to render the data in the box without refreshing the browser, and further CSS attribute manipulation can occur with Javascript and a refresh can then be conducted to apply the changes. In this mode of operation, when a user creates a box, the user chooses which kind of box it is. Then the box name and/or its associated report name are stored. The pipeline's first two phases are conducted and the transformed data can be then rendered within the box and not the whole screen. Thus, the page does not need to be refreshed. The information shows up on the screen and then the user can make style changes using the tool box. As the tool box is written in Javascript, the CSS attribute alterations are also done in Javascript and not through the third phase of the pipeline. The Javascript takes the XML document that described just the report and copies it and associated the report with the box. After the style changes have been conducted, a refresh can be applied and the changes can be applied to the whole box or whole page. In another alternative embodiment of the invention, the pipeline process may incorporate the use of AJAX (Asynchronous JavaScript and XML) which is an open source protocol that allows content on web pages to update immediately when a user performs an action without waiting for a whole new page to load. AJAX combines several programming tools including JavaScript, dynamic HTML (DHTML), Extensible Markup Language (XML), cascading style sheets (CSS), the Document Object Model (DOM), and the Microsoft object, XMLHttpRequest to build interactive web applications that process user requests immediately.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A system for modifying the content of portal screens for a web community comprising:
a plurality of web communities accessible through the network, wherein each web community is associated with a plurality of portal screens and each portal screen is associated with a plurality of report data;
a user computer device capable of accessing and rendering the plurality of portal screens;
a user interface associated with the plurality of portal screens accessible on the user computer device, wherein the user interface provides access to a remote data source through the network to locate and retrieve the plurality of report data to be associated with the plurality of portal screen; and
at least one server connected to a user computer device through a network, wherein the at least one server is operable to retrieve at least some of the report data, identify an abstract data type associated with the report data; transform the retrieved report data into an abstract data type; execute a plurality of structure transformations on the abstract data type to achieve a desired data structure; and transmit the desired data structure through the network to the user computer device.

2. The system of claim 1, further comprising a plurality of tools is accessible through the user interface for altering the display of the retrieved report data on a portal screen displayed on a user computer device.

3. The system of claim 2, wherein the plurality of tools includes one or more tools selected from the group consisting of a box tool, report tool, form tool, translate tool, community tool, style tool and a module tool.

4. The system of claim 1, wherein the plurality of portal screens are web pages.

5. The system of claim 1, wherein the remote database is selected from the group consisting of a resource center, local database, and an external data source.

6. A method of modifying the content on a portal screen using a tool box interface comprising:
creating a box on the portal screen through the tool box interface;
associating at least one report with the box, wherein the report is associated with a plurality of portal screen content;
modifying the portal screen content associated with the report according to selections entered through the tool box interface; and
rendering the portal screen content associated with the report on the portal screen.

7. The method of claim 6, further comprising, querying one of the following groups consisting of a resource center, local database, or external data source through a file browser associated with the tool box interface to retrieve the report to be associated with the box.

8. The method of claim 6, wherein modifying the portal screen content associated with the report according to selections entered through the tool box interface includes entering the selections through a structure tool interface and a style tool interface, wherein a data structure to be associated with the portal screen content is selected through the structure tool interface and a plurality of style attributes to be associated with the portal screen content is selected through the style tool interface.

9. The method of claim 6, wherein modifying the portal screen content associated with the report according to selections entered through the tool box interface includes entering the selections through a plurality of (what you see is what you get) WYSIWYG editors accessible through the tool box interface.

10. The method of claim 6, wherein rendering the portal screen content associated with the report on the portal screen includes displaying the portal screen content associated with report inside the box associated with the report.

11. A method of data transformation comprising:
extracting a report name from a report definition;
retrieving report data corresponding to the extracted report name;
identifying an abstract data type associated with the report data;
transforming the retrieved report data into an abstract data type; and
executing a plurality of structure transformations on the abstract data type to achieve a desired data structure.

12. The method of claim 11 further comprising,
determining a plurality of desired style attributes to be associated with the desired data structure;
associating the plurality of desired style attributes with the desired data structure;
formatting the data to be rendered on a particular output device; and
rendering the desired data structure on an output device.

13. The method of claim 11, wherein retrieving report data corresponding to the extracted report name includes accessing a database where the report data is located.

14. The method of claim 11, wherein retrieving report data corresponding to the extracted report name includes utilizing Simple Object Access Protocol (SOAP) calls to retrieve the report data.

15. The method of claim 11, wherein retrieving report data corresponding to the extracted report name includes wrapping the column names associated with the report data around the report data as Extensible Markup Language (XML) tags.

16. The method of claim 15, wherein transforming the retrieved report data into an abstract data type includes changing the XML tags wrapped around the report data based at least in part on the desired data structure.

17. The method of claim 11, further comprising, building (cascading style sheets) CSS tags associated with the style attributes of the report data.

18. The method of claim 11, further comprising, processing the report data with external application software; and making the processed report data available for download.

19. The method of claim 12, further comprising building CSS tags associated with the style attributes of the report data; and wherein associating the desired style attributes with the desired data structure includes converting the CSS tags associated with the style attributes of the report data based at least in part on the desired style attributes.

20. The method of claim 12, wherein the rendering of the desired data structure on an output device is done by refreshing only a portion of the screen associated with the output device.
